(19) United States
(12) Patent Application Publication
(10) Pub. No.: US 2015/0237704 A1
(43) Pub. Date: Aug. 20, 2015

(54) ILLUMINATION SYSTEM COMPRISING AN INTEGRATED PROJECTION UNIT

(71) Applicant: ZUMTOBEL LIGHTING GMBH, Dornbirn (AT)

(72) Inventor: Martin Siegel, Bodolz (DE)

(21) Appl. No.: 14/427,242

(22) PCT Filed: Sep. 10, 2013
(86) PCT No.: PCT/EP2013/068691

§ 371 Date: Mar. 10, 2015

(30) Foreign Application Priority Data
Sep. 12, 2012 (DE) 20 2012 103 472.7

(51) Int. Cl. H05B 37/02; G03B 21/14

(52) U.S. Cl. CPC H05B 37/0227; G03B 21/14

(57) ABSTRACT

An illumination system is disclosed having at least a control unit, a projection unit, an illumination unit, and a sensor unit. The sensor unit is designed to capture a position of a movement of a person in a space. The control unit is designed to actuate the projection unit in dependence on the position of the movement, in order to project an operating element onto a surface of the space for controlling the illumination unit. Accordingly the user sees the operating element only when the user needs it. Furthermore, the user can comfortably reach the operating element from the position of the user.

The invention relates to a lighting system comprising at least one lighting device and a projection unit.

For the manual control of lighting devices, light switches, operating panels or else increasingly touch-sensitive displays are typically used nowadays. However, these are installed in a fixed manner in the room or on the respective light. As an alternative to this, there are only remote controls which, although they are not fixed in location, assume that the user carries said remote controls with him.

Thus, the ability to operate the lighting devices irrespective of the location of the user or of the operating element is not provided.

German laid-open specification DE 10 2010 023 425 A1 shows a control device with projector. Here, a fixed-location projector projects an operating element at a defined position on a surface. User interaction with this operating element is detected by a movement sensor. On the basis of a detected movement pattern, an operating procedure of a connected lighting device is triggered. However, the control device shown there likewise permits only fixed-location operation.

The invention is based on the object of devising a lighting system which permits control of a lighting device irrespective of the whereabouts of the user and irrespective of the mounting location of the lighting device.

According to the invention, the object for the lighting system is achieved for the features of the independent claim 1. Advantageous developments are the subject matter of the subclaims referring back thereto.

A lighting system according to the invention has at least one control device, a projection unit, a lighting device and a sensor unit. The sensor unit is configured to detect a position of a movement of an individual in a room. The control device is configured to activate the projection unit on the basis of the position of the movement, in order to project an operating element for controlling the lighting device onto a surface of the room. It is thus ensured that the user sees the operating element only when he needs it. Furthermore, he can thus comfortably reach the operating element from his position.

Preferably, the sensor unit is configured to detect an operating input from the individual by means of the projected operating element. The control device is then configured to control the lighting device on the basis of the detected operating input. Thus, simple operation of the lighting device is achieved. Furthermore, it is thus possible to dispense with conventional operating devices such as switches.

Preferably, the sensor unit has at least one infrared sensor and/or a camera and/or a distance sensor. Thus, accurate and simple detection of the movement is achieved.

The sensor unit is advantageously configured to detect the position of at least one individual in the room. The control device is then configured to control the lighting device on the basis of the position of the individual in the room. The operating device is thus always projected in the vicinity of the user.

The sensor unit is preferably configured to detect the position of the lighting device in the room. The control device is then configured to control the lighting device on the basis of the position of the latter. Thus, it is possible to take position changes of the lighting devices into account without renewed calibration of the system.

Preferably, the sensor unit is configured to detect the reflectivity of at least one surface in the room. The control device is then configured to control the lighting device on the basis of the reflectivity. Thus, a homogenous lighting intensity in the room can be achieved.

Advantageously, the sensor unit is configured to determine a lightness of at least one surface in the room. The control device is then configured to control the lighting device on the basis of the determined lightness. Thus, a homogenous lighting intensity in the room can be achieved.

The sensor unit is preferably configured to determine at least a partial room geometry of the room. Thus, the lighting can be adapted simply to the room geometry without the system having to be recalibrated at any change in the room geometry, such as for example as a result of the use of new pieces of furniture.

The control device is preferably further configured to select the surface for the projection of the operating element on the basis of the determined room geometry. It is thus ensured that the operating element is projected onto easily accessible and visible surfaces.

The control device is advantageously configured to adapt the projection of the operating element to an attitude and position of the surface for the projection of the operating element by means of distortion and/or stretching and/or enlargement and/or reduction in size. Thus, the operating element has a uniform size and shape irrespective of the room geometry.

The control device is preferably configured to determine a suitable escape route on the basis of the detected room geometry. Alternatively, the control device is configured to maintain a previously determined escape route. Advantageously, the control device is further configured to activate the projection unit in such a way that the latter highlights the escape route optically, at least during emergency operation, or to activate the lighting device in such a way that the latter highlights the determined escape route optically, at least during emergency operation. Thus, in the event of an emergency, finding a suitable escape route is made easier.

The projection unit and the sensor unit are preferably incorporated in a common housing. Alternatively, the projection unit and the sensor unit are incorporated in separate housings at different positions in the room. Thus, very flexible implementation of the system is possible.

The lighting system preferably has a plurality of sensor units and/or a plurality of projection units and/or a plurality of lighting devices. Thus, it is possible to compensate for masking effects.

The sensor unit is preferably configured to determine, during each of the detected movements, whether the movement is an operating procedure. Thus, erroneous operations can reliably be ruled out.

The invention will be described by way of example below by using the drawing, in which an advantageous exemplary embodiment of the invention is illustrated. In the drawing:

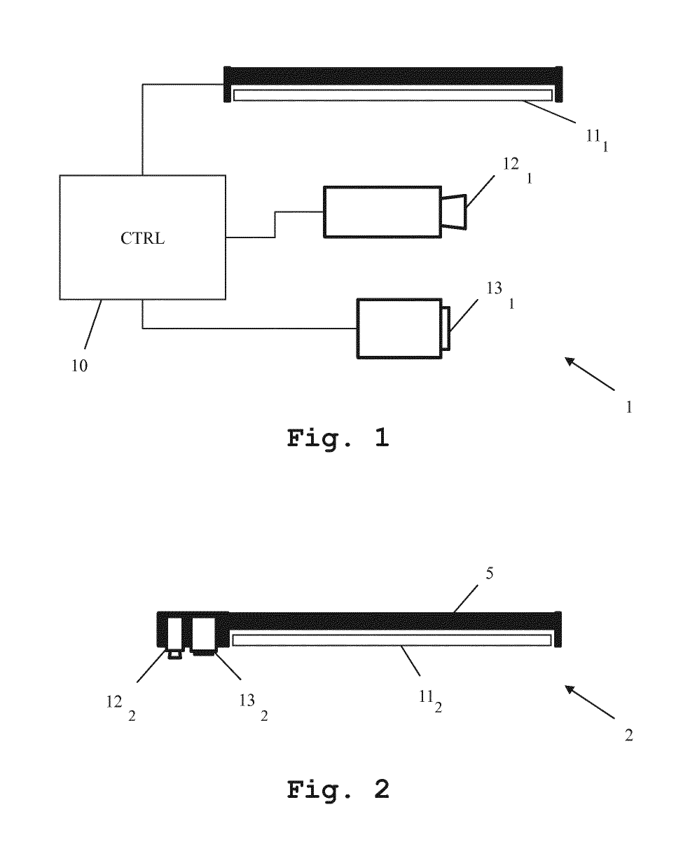

FIG. 1 shows a first exemplary embodiment of the lighting system according to the invention;

FIG. 2 shows a second exemplary embodiment of the lighting system according to the invention;

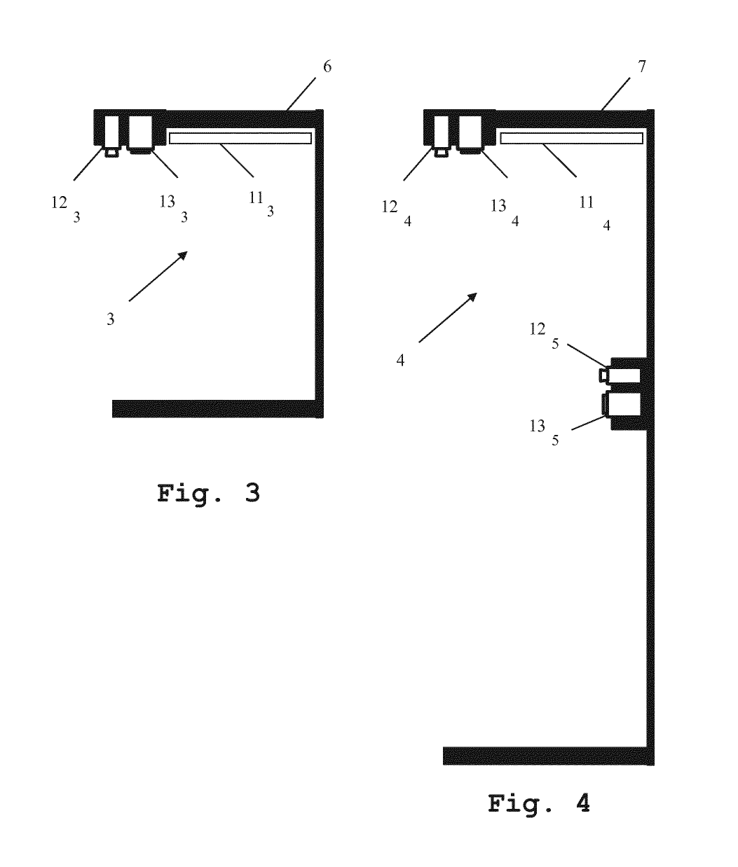

FIG. 3 shows a third exemplary embodiment of the lighting system according to the invention;

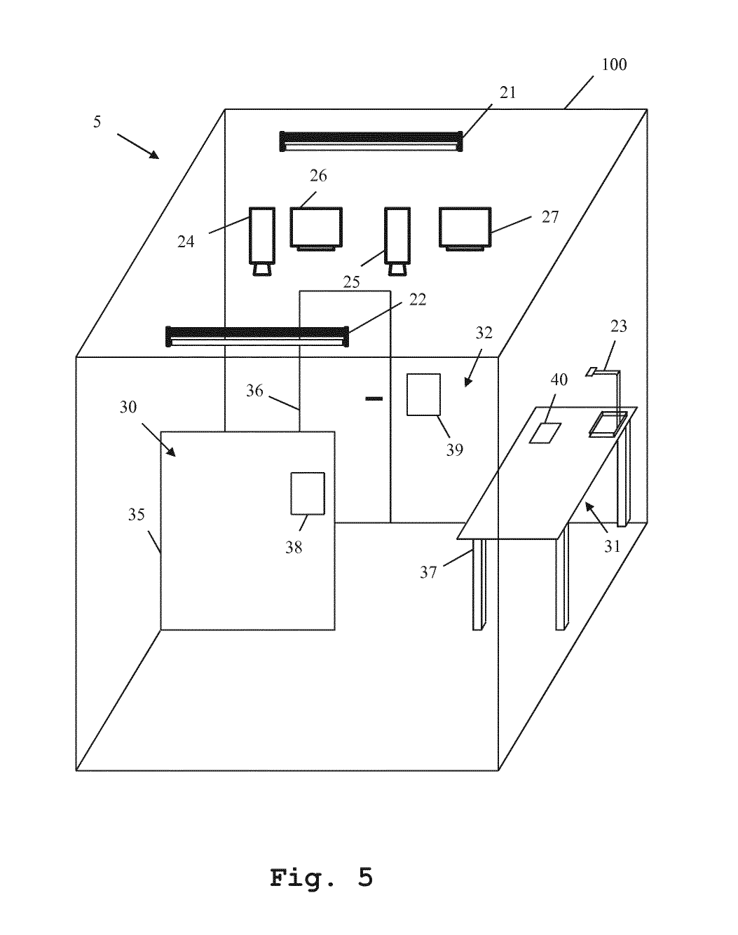

FIG. 4 shows a fourth exemplary embodiment of the lighting system according to the invention;

FIG. 5 shows a fifth exemplary embodiment of the lighting system according to the invention;

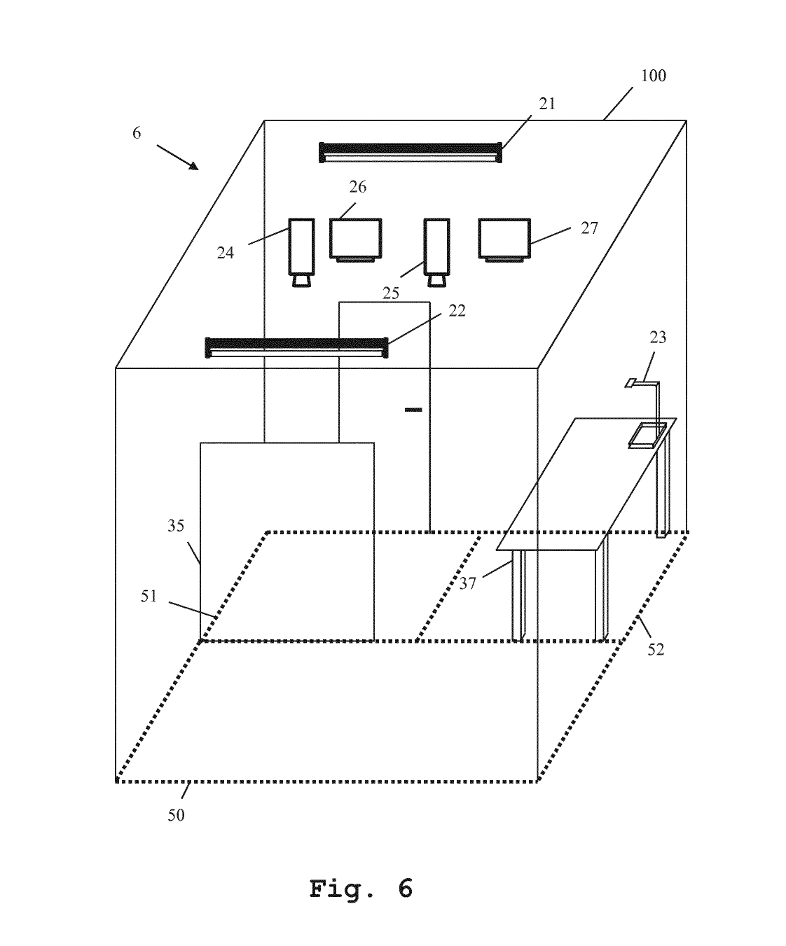

FIG. 6 shows a sixth exemplary embodiment of the lighting system according to the invention, and

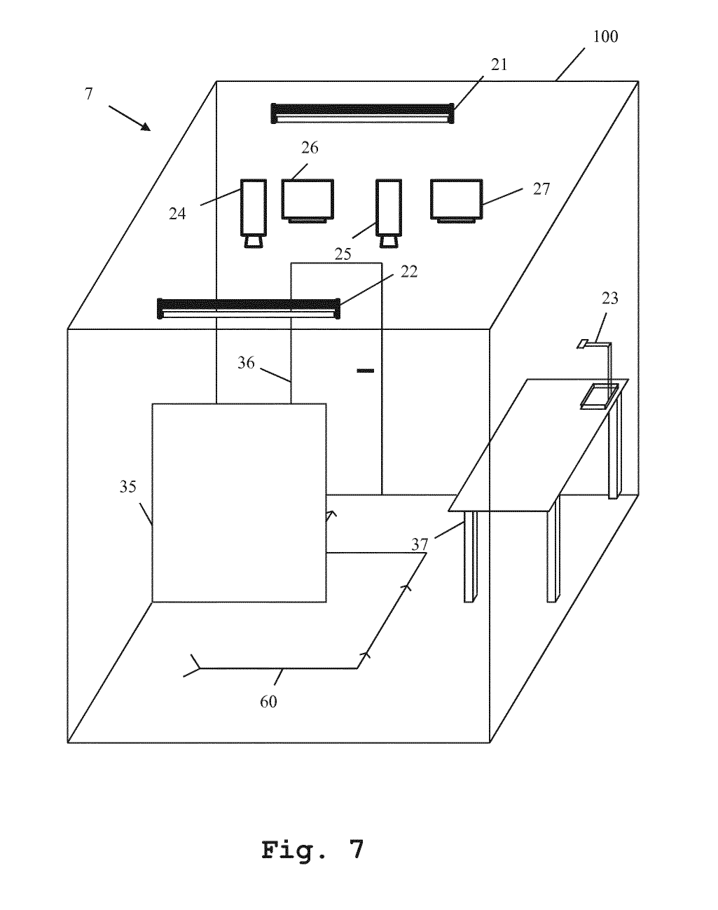

FIG. 7 shows a seventh exemplary embodiment of the lighting system according to the invention.

Firstly, by using FIG. 1-FIG. 4, various basic implementations of the exemplary embodiments of the lighting system according to the invention will be shown. Then, by using FIG. 5-FIG. 7, the more exact function of the various exemplary embodiments of the lighting system according to the invention will be discussed. Identical elements in similar figures have to some extent not been repeatedly illustrated and described.

FIG. 1 shows a first exemplary embodiment of the lighting system 1 according to the invention. It includes a control device 10, a lighting device 11₁, a projection unit 12₁ and a sensor unit 13₁. The control device 10 is connected to the lighting device 11₁, the projection unit 12₁ and the sensor unit 13₁. In the exemplary embodiment illustrated here, the connection is made by means of leads. A connection by means of wire-free connections is also possible.

The lighting device 11₁, the projection unit 12₁ and the sensor unit 13₁ are each accommodated in an independent housing. The control device 10 can likewise be accommodated in an independent housing. However, the control device 10 can also be incorporated in one of the housings of the lighting device 11₁, the projection unit 12₁ or the sensor unit 13₁.

The control device controls the lighting device 11₁, the projection unit 12₁ and the sensor unit 13₁. Here, the control device 10 defines which images are displayed at which position by the projection unit 12₁. Furthermore, the control device 10 processes the measured results from the sensor unit 13₁. Furthermore, the control device 10 defines whether and how intensely the lighting device 11₁ is activated.

The exact interplay of the individual elements will be discussed in more detail by using FIG. 5-FIG. 7.

FIG. 2 shows a second exemplary embodiment of the lighting system 2 according to the invention. A lighting device 11₂, a projection unit 12₂ and a sensor unit 13₂ are integrated in a common housing 5. In addition, a control device, not illustrated here, is installed in the housing 5. The lighting device 11₂, the projection unit 12₂, the sensor unit 13₂ and the control device, not illustrated here, are connected to one another, as can also be seen in FIG. 1. Alternatively, the control device 10 can also be arranged outside the housing 5.

The embodiment of the lighting system 2 illustrated here is provided for ceiling mounting. The projection unit 12₂ and the sensor unit 13₂ point downward in the direction of the room. The lighting device 11₂ is likewise configured such that the main emission direction is downward, i.e. opposite to the ceiling.

However, the embodiment of the lighting system 5 illustrated here can likewise be used for wall mounting without structural changes. Mounting on a piece of furniture is also conceivable.

A third exemplary embodiment of the lighting system 3 according to the invention is illustrated in FIG. 3. It includes a lighting device 11₃, a projection unit 12₃ and a sensor unit 13₃ in a common housing 6.

Here, the housing 6 is configured such that the lighting system forms a standing lamp to be set up, for example, on a table. The projection unit 12₃ and the sensor unit 13₃ are aimed in the direction of the surface on which the lighting system 6, i.e. the standing lamp, is placed.

A fourth exemplary embodiment of the lighting system 4 according to the invention is illustrated in FIG. 4. Here, too, a common housing 7 includes a lighting device 11₄, a projection unit 12₄ and a sensor unit 13₄. Here, the housing 7 forms a standard lamp, i.e. a lamp which is placed on the floor. The projection unit 12₄ and the sensor unit 13₄ are arranged in such a way that they point in the direction of the floor. In addition, the housing 7 has a second projection unit 12₅ and a second sensor unit 13₅, which are fixed to a foot of the standard lamp which is integrated into the housing 7. Said units point in a direction deviating by 90° with respect to the floor. An alignment in the direction of the floor is also conceivable.

FIG. 5 shows a fifth exemplary embodiment of the lighting system according to the invention. Located in a room 100 are a table 37 and a partition 35. The room 100 also has a door 36. The door is not part of the lighting system.

Here, the lighting system 5 has a first lighting device 21 and a second lighting unit 22. These are both fixed to the ceiling of the room 100. Furthermore, a first projection unit 24 and a second projection unit 25 are arranged on the ceiling of the room 100. Moreover, a first sensor unit 26 and a second sensor unit 27 are arranged on the ceiling of the room 100. Also part of the lighting system 5 is a third lighting device 23, which is constructed in the form of a standard lamp on the table 37.

The lighting system 5 has a control device, which is not illustrated here. For clarity, in addition all the connecting leads of the individual elements of the lighting system are not illustrated here. However, the connections are made in accordance with FIG. 1. This means that each individual element of the lighting system is connected to the control device, not illustrated here. However, the connection can be made in a wire-free manner.

The sensor units 26 and 27 monitor the room 100. They determine positions within the room 100 at which movements take place. If a detected movement is detected by the control device as an operating procedure, the control device activates one of the projection units 24, 25 in such a way that the latter projects an operating element onto a surface of the room 100 that is suitable for the purpose in the vicinity of the position of the detected movement.

The sensor units 26, 27 determine at least a partial room geometry of the room 100, in order thus to determine suitable surfaces 30, 31, 32 for the projection of the operating elements 38, 39 and 40. Here, a suitable position for the projection of an operating element 38, 39, 40 is distinguished by a flat and/or low-texture and/or low-contrast and/or light surface, and is arranged in an operating position that is ergonomic for the user. Furthermore, when determining the location at which the operating elements 38-40 are projected, care is taken that no doors are concealed. Care is also taken that no windows are concealed, although the latter are not illustrated here.

The sensor units 26, 27 also monitor the movements of the user during his interaction with the projected operating elements 38, 39, 40. If a movement of the user with respect to an operating element 38-40 is detected as an operating input, the corresponding lighting device 21, 22, 23 is activated accordingly.

The projected operating elements 38-40 can each be merely simple switches for only the nearest lighting device 21-23. Alternatively, a plurality of simple switches for each lighting device 21-23 arranged in the room 100 can also be projected in each of the operating elements 38-40. The operating elements 38-40 can also be configured in such a way that the control of lighting scenarios is possible. Interactive operation with changing displays of the respective operating element 38-40 is also conceivable.

Thus, for example, before any operating element is projected, if a movement of the user on the upper side of the table 37 in the area of the lighting device 23 is detected by the sensor unit 27, then this information is passed on to the control device. If the control device determines that the movement is an operating procedure, i.e. a specific movement with the aim of changing the lighting situation, then the control device determines for which lighting device 21-23 operation could be needed. The high physical proximity of the movement of the user to the lighting device 23 here suggests a desire to operate the lighting device 23. The control device thus arranges for the projection unit 25 to project a simple switch as operating element 40, which is suitable for switching the lighting device 23.

If the user then makes an operating gesture, for example touching the projected switch, then this is detected by the sensor unit 27 and converted by the control device into a switching operation of the lighting device 23.

However, it may occur that the user stands between the projected operating element 38-40 and one of the sensor units 26, 27. In this case, reliable detection of the operating procedure cannot be carried out by the concealed sensor unit 26, 27. In this case, however, reliable detection of the operating procedure can be carried out by the second sensor unit 26, 27 kept in reserve. The response is likewise with the projection units 24, 25. If a user conceals a projection of an operating element in this way, an alternative projection unit 24, 25 performs the projection.

This can be ensured either by all the suitable projection units 24, 25 always projecting all the projected operating elements, or alternatively, concealment can be detected by the sensor units 26, 27. In this case, the control device then activates the projection units 24, 25 appropriately in order to achieve uninterrupted projection.

In an advantageous development, the sensor units 26, 27 are additionally configured to determine the level of lighting in the room 100. The determination is carried out for different surfaces of the room 100. The lighting devices 21-23 are activated on the basis of the determined lightnesses of the surfaces. For instance, if it is established that the surface 31 of the table 37 is very dark, then there is a high probability of a desired operating procedure with respect to the lighting device 23.

In a further advantageous refinement, the sensor units 26, 27 are configured to determine reflectivities of the various surfaces 30-32 within the room 100. Control of the lighting devices 21-23 on the basis of the determined reflectivities is also possible.

In a further advantageous refinement, the sensor units 26, 27 are configured to detect the positions of the lighting devices 21-23 in the room. It is then not necessary to communicate the positions of the lighting devices 21-23 to the control device. Moreover, it is then possible to operate with mobile lighting devices, such as battery-operated lighting devices or freely positionable cable-operated lighting devices, without having to recalibrate the system after each change in the position of the lighting device.

Furthermore, control of the light emission characteristics of the lighting devices 21-23 is also possible. For example, the sensor units 26, 27 determine the position of the user in the room. The control device then activates the lighting devices 21-23 in such a way that the emission characteristics achieve a lighting effect set by the user.

During the projection of the operating elements 38-40, the room geometry is preferably taken into account. This means that distortion and/or stretching and/or enlargement and/or reduction in the size of the operating elements takes place in order to achieve an identical size and shape of the corresponding operating element, irrespective of the attitude and orientation of the projection surface 30-32.

The sensor unit 13₁-13₅, 26, 27 comprises at least one infrared sensor and/or a camera and/or a distance sensor. Integration of further sensors is also possible.

In addition, mounting the sensor units 26, 27 and/or projection units 24, 25 at different positions is conceivable. Thus, for example, said sensor units and/or projection units could also be fixed to walls or to pieces of furniture.

A sixth exemplary embodiment of the lighting system 6 according to the invention is illustrated in FIG. 6. The lighting system 6 largely corresponds to the lighting system 5. However, in the exemplary embodiment shown here by way of example, an additional function of the lighting system 6 is shown. The sensor units 26, 27 are configured to determine areas 50, 51, 52 of the room 100 from the determined room geometry. These areas are defined by using structures occurring in the room. Thus, here the first area 50 is separated from the second area 51 by the partition 35. The second area 51 comprises the area between the partition 35 and the door. A third area 52 comprises an area around the table 37.

Here, the sensor units 26, 27 are configured for the purpose of not only detecting the position of movements in the room 100 but additionally detecting the position of individuals in the room 100. Here, by using the detected positions of individuals in the room 100, the control device determines the areas 50-52 in which the individuals are located. This is taken into account when controlling the lighting devices 21-23. If, for example, at the start one individual is in the area 52 and said individual has activated the lighting device 23, then the control device would deactivate the lighting device 23 as soon as the individual leaves the area 52 and, for example, enters the area 50.

By means of the specific activation of lighting devices 21-23 in newly used areas of the room, an operating procedure by the user is dispensed with and as a result of specific deactivation of lighting devices 21-23 in areas 50-52 of the room 100 that are no longer used, a noticeable amount of energy can be saved.

A seventh exemplary embodiment of the lighting system 7 according to the invention is illustrated in FIG. 7. This largely corresponds to the lighting system from FIG. 5 and FIG. 6.

Here, additional functionality is illustrated. Thus, the control device determines, for example in cooperation with a fire alarm or other sensors which are part of the lighting system, whether there is an emergency operation. As soon as there is such an emergency operation, the control device activates the projection units 24, 25 in such a way that said units project an escape route 60 in the room 100. The escape route 60 can be projected onto the floor or else onto walls or onto objects. The projected escape route 60 can either be permanently predefined or determined in cooperation with the sensor units 26, 27. In this case, the sensor units 26, 27 determine the areas of the room 100 in which there are no obstacles. The control device then calculates, from a detected position of an individual in the room 100, an escape route 60 to the nearest door 36. Said control device uses the determined room geometry for this purpose. In addition, highlighting of the escape route 60 by means of appropriate activation of the lighting devices 21-23 is also conceivable.

The invention is not restricted to the exemplary embodiment illustrated. As already mentioned, different lighting devices, sensor units and projection units can be integrated into the lighting system. All the features described above or features shown in the figures can advantageously be combined with one another as desired within the context of the invention.

1. A lighting system comprising:
at least one control device,
a projection unit,
a lighting device and
at least one sensor unit,
wherein
the sensor unit is configured to detect a position of a movement of an individual in a room,
the control device is configured to activate the projection unit on the basis of the position of the movement, in order to project an operating element for controlling the lighting device onto a surface of the room.

2. The lighting system as claimed in claim 1,
wherein
the sensor unit is configured to detect an operating input from the individual by means of the projected operating element, and
the control device is configured to control the lighting device on the basis of the detected operating input.

3. The lighting system as claimed in claim 1,
wherein
the sensor unit has at least one infrared sensor and/or a camera and/or a distance sensor.

4. The lighting system as claimed in claim 1,
wherein
the sensor unit is configured to detect the position of at least one individual in the room, and
the control device is configured to control the lighting device on the basis of the position of the individual in the room.

5. The lighting system as claimed in claim 1,
wherein
the sensor unit is configured to detect the position of the lighting device in the room, and
the control device is configured to control the lighting device on the basis of the position of the latter.

6. The lighting system as claimed in claim 1,
wherein
the sensor unit is configured to detect the reflectivity of at least one surface in the room, and
the control device is configured to control the lighting device on the basis of the reflectivity.

7. The lighting system as claimed in claim 1,
wherein
the sensor unit is configured to determine a lightness of at least one surface in the room, and
the control device is configured to control the lighting device on the basis of the determined lightness.

8. The lighting system as claimed in claim 1,
wherein
the sensor unit is configured to determine at least a partial room geometry of the room.

9. The lighting system as claimed in claim 8,
wherein
the control device is configured to select the surface for the projection of the operating element on the basis of the determined room geometry.

10. The lighting system as claimed in claim 8,
wherein
the control device is configured to adapt the projection of the operating element to an attitude and position of the surface for the projection of the operating element by means of distortion and/or stretching and/or enlargement and/or reduction in size.

11. The lighting system as claimed in claim 8,
wherein
the control device is configured to determine a suitable escape route on the basis of the detected room geometry, or
the control device is configured to maintain a previously determined escape route.

12. The lighting system as claimed in claim 11,
wherein
the control device is further configured to activate the projection unit in such a way that the latter highlights the escape route optically, at least during emergency operation, or to activate the lighting device in such a way that the latter highlights the determined escape route optically, at least during emergency operation.

13. The lighting system as claimed in claim 1,
wherein
the projection unit and the sensor unit are incorporated in a common housing, or
the projection unit and the sensor unit are incorporated in separate housings at different positions in the room.

14. The lighting system as claimed in claim 1,
wherein
the lighting system has a plurality of sensor units and/or a plurality of projection units and/or a plurality of lighting devices.

15. The lighting system as claimed in claim 1,
wherein
the sensor unit is configured to determine, during each of the detected movements, whether the movement is an operating procedure.
